(19) United States
(12) Patent Application Publication
(10) Pub. No.: US 2026/0146654 A1
(43) Pub. Date: May 28, 2026

(54) HARMONIC GEAR WITH TORQUE LIMITING SLEEVE

(71) Applicant: Hamilton Sundstrand Corporation, Charlotte, NC (US)

(72) Inventor: Derick S. Balsiger, Prescott Valley, AZ (US)

(21) Appl. No.: 18/956,154

(22) Filed: Nov. 22, 2024

(51) Int. Cl. F16D 7/02; B64C 13/34; F16H 49/00

(52) U.S. Cl. CPC F16D 7/021; F16H 49/001; B64C 13/34

(57) ABSTRACT

Gearbox assemblies for actuators and aircraft actuator systems including the same. The gearbox assemblies include a housing, a gear assembly arranged within the housing, and a torque limiting sleeve arranged on an exterior of the housing, wherein the torque limiting sleeve is axially positioned radially outward from the gear assembly.

### BACKGROUND

The subject matter disclosed herein generally relates to actuators and, more particularly, to actuators having harmonic gears with torque limiting sleeves.

Various types of actuators, such as leadscrews and nuts, may be used in aircraft and avionic application for various actuations. Such actuators can include, for example, doors, flaps, ailerons, control surfaces, thrust reversers, and the like. Some actuation systems require a limit on the torque output to protect against damage to associated components. For example, torque limits may be implemented to prevent damage to aircraft structural components during operation. Conventional solutions for torque limiting include, for example, external torque limiters, maximum limits imposed on motors or drivers associated with the actuators, and/or controlled harmonic gear ratcheting. The torque limiting may be imposed to limit the amount of torque to remain below a structural limit that is based, at least in part, on the component that is controlled or operated by the actuator. Improved torque limiting and control thereof may provide additional benefits as described herein.

### SUMMARY

According to some embodiments, gearbox assemblies for actuators are provided. The gearbox assemblies include a housing, a gear assembly arranged within the housing, and a torque limiting sleeve arranged on an exterior of the housing, wherein the torque limiting sleeve is axially positioned radially outward from the gear assembly.

In addition to one or more of the features described herein, or as an alternative, further embodiments of the gearbox assemblies may include that the torque limiting sleeve is integrally formed with the housing, and the torque limiting sleeve comprises a radial thickness of the housing at a position axially outward from the gear assembly that is greater than a radial thickness of the housing not axially aligned with the gear assembly.

In addition to one or more of the features described herein, or as an alternative, further embodiments of the gearbox assemblies may include that the torque limiting sleeve comprises at least two sleeve sections that are secured together about the housing.

In addition to one or more of the features described herein, or as an alternative, further embodiments of the gearbox assemblies may include that torque limiting sleeve comprises an inner diameter surface that is arranged in contact with an outer diameter surface of the housing.

In addition to one or more of the features described herein, or as an alternative, further embodiments of the gearbox assemblies may include that the torque limiting sleeve is retained on the housing by a clamping force and friction between the inner diameter surface and the outer diameter surface.

In addition to one or more of the features described herein, or as an alternative, further embodiments of the gearbox assemblies may include that the torque limiting sleeve is removably attached to the housing.

In addition to one or more of the features described herein, or as an alternative, further embodiments of the gearbox assemblies may include that the torque limiting sleeve and the housing are formed from the same material.

In addition to one or more of the features described herein, or as an alternative, further embodiments of the gearbox assemblies may include that the torque limiting sleeve is formed a material different from a material of the housing.

In addition to one or more of the features described herein, or as an alternative, further embodiments of the gearbox assemblies may include that the torque limiting sleeve has an axial length that is equal to an axial length of the gear assembly within the housing.

In addition to one or more of the features described herein, or as an alternative, further embodiments of the gearbox assemblies may include that the torque limiting sleeve has an axial length that is greater than an axial length of the gear assembly within the housing.

In addition to one or more of the features described herein, or as an alternative, further embodiments of the gearbox assemblies may include that the torque limiting sleeve has an axial length that is less than an axial length of the gear assembly within the housing.

In addition to one or more of the features described herein, or as an alternative, further embodiments of the gearbox assemblies may include that the gear assembly comprises an elliptical hub, a harmonic wave generator bearing arranged radially outward from the elliptical hub, a harmonic gear flex spline arranged radially outward from the harmonic wave generator bearing, and a harmonic circular gear arranged radially outward from the harmonic gear flex spline, wherein the harmonic gear flex spline is configured to engage with the harmonic circular gear.

In addition to one or more of the features described herein, or as an alternative, further embodiments of the gearbox assemblies may include that the elliptical hub is coupled to an input shaft and the harmonic gear flex spline is coupled to an output shaft.

In addition to one or more of the features described herein, or as an alternative, further embodiments of the gearbox assemblies may include an axial stop installed on an exterior of the housing and configured to secure an axial position of the torque limiting sleeve on the housing.

In addition to one or more of the features described herein, or as an alternative, further embodiments of the gearbox assemblies may include that the housing comprises a flange, wherein the torque limiting sleeve is fixedly connected to the flange.

According to some embodiments, aircraft actuator systems are provided. The aircraft actuator systems include a component to be actuated, an actuator, and a gearbox assembly operably arranged between the actuator and the component to be actuated. The gearbox assembly includes a housing, a gear assembly arranged within the housing, wherein the gear assembly is configured to couple an input shaft connected to the actuator with an output shaft connected to the component to be actuated, and a torque limiting sleeve arranged on an exterior of the housing, wherein the torque limiting sleeve is axially positioned radially outward from the gear assembly.

In addition to one or more of the features described herein, or as an alternative, further embodiments of the aircraft actuator systems may include that the torque limiting sleeve is removably attached to the housing.

In addition to one or more of the features described herein, or as an alternative, further embodiments of the aircraft actuator systems may include that the torque limiting sleeve has an axial length that is equal to an axial length of the gear assembly within the housing.

In addition to one or more of the features described herein, or as an alternative, further embodiments of the aircraft actuator systems may include that the gear assembly comprises an elliptical hub, a harmonic wave generator bearing arranged radially outward from the elliptical hub, a harmonic gear flex spline arranged radially outward from the harmonic wave generator bearing, and a harmonic circular gear arranged radially outward from the harmonic gear flex spline, wherein the harmonic gear flex spline is configured to engage with the harmonic circular gear.

In addition to one or more of the features described herein, or as an alternative, further embodiments of the aircraft actuator systems may include that the elliptical hub is coupled to the input shaft and the harmonic gear flex spline is coupled to the output shaft.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic illustration of an aircraft that may incorporate embodiments of the present disclosure;

FIG. 2A is a schematic illustration of a gear box assembly that may incorporate embodiments of the present disclosure;

FIG. 2B illustrates the gear box assembly of FIG. 2A with a torque limiting sleeve in accordance with an embodiment of the present disclosure installed thereon;

FIG. 2C is a cross-sectional illustration of the gear box assembly and torque limiting sleeve of FIG. 2B as viewed along the line 2C-2C of FIG. 2B;

FIG. 2D is a cross-sectional illustration of the gear box assembly and torque limiting sleeve of FIG. 2B as viewed along the line 2D-2D of FIG. 2B;

FIG. 3 is a schematic illustration of another configuration of a torque limiting sleeve applied to a housing of a gear box assembly in accordance with an embodiment of the present disclosure;

FIG. 4 is a schematic illustration of another configuration of a torque limiting sleeve applied to a housing of a gear box assembly in accordance with an embodiment of the present disclosure;

FIG. 5 is a schematic illustration of another configuration of a torque limiting sleeve applied to a housing of a gear box assembly in accordance with an embodiment of the present disclosure;

FIG. 6A is a schematic illustration of another configuration of a torque limiting sleeve in an integral configuration with a housing of a gear box assembly in accordance with an embodiment of the present disclosure; and

FIG. 6B is a cross-sectional illustration of the gearbox assembly of FIG. 6A as viewed along the line 6B-6B shown in FIG. 6A.

### DETAILED DESCRIPTION

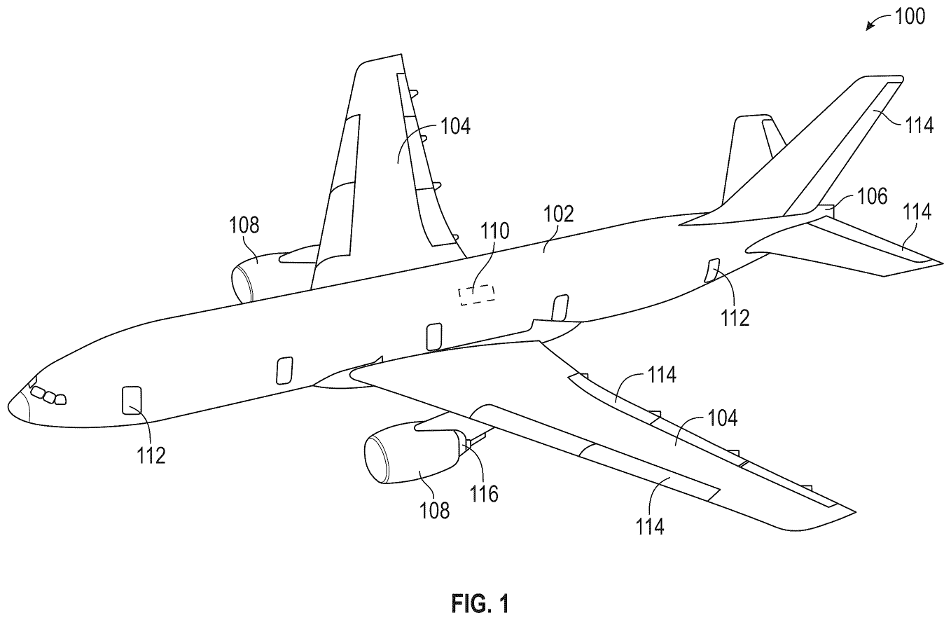

Referring to FIG. 1, a schematic illustration of an aircraft 100 that may incorporate embodiments of the present disclosure is shown. The aircraft 100 includes a fuselage 102, wings 104, and a tail 106. In this illustrated embodiment, the aircraft 100 includes wing-mounted aircraft power systems 108. The wing-mounted aircraft power systems 108 may be conventional gas turbine engines or other propulsion systems as known in the art. In other configurations, aircraft employing embodiments of the present disclosure may include fuselage-mounted configurations, tail-mounted configurations, and/or combinations of wing-, fuselage-, and tail-mounted systems. The aircraft power systems 108 may be used to generate thrust for flight and may also be used to generate onboard electrical power. The aircraft 100 may also include one or more auxiliary power units 110 that may be configured to generate power. The aircraft 100 includes doors 112 and aircraft flight control surfaces 114 (e.g., ailerons, flaps, flaperons, stabilizers, etc.). The aircraft power systems 108 may include thrust reversers 116, as will be appreciated by those of skill in the art.

Control or actuation of various components of the aircraft 100 may be enabled through use of actuators. Actuators onboard aircraft can be used for, for example, actuating the doors 112, the flight control surfaces 114, the thrust reversers 116, landing gear, interior doors, seats, and the like. The actuators may be driven by a motor, generator, or the like. The motor or generator may provide input into a gearing system to cause an output that can be used to control one or more actuated components. A harmonic gearbox (or strain wave gearbox) may be arranged to transmit power from the motor/generator to a controlled component, with high precision. Harmonic gearboxes have three main components, including, a wave generator, a flex spline, and a circular spline. In operation, the wave generator deforms the flex spline into an elliptical shape, which then engages with the teeth of the circular spline, allowing for transmission of rotational force from the motor, through the harmonic gearbox, and into an output shaft that is coupled to or part of a controlled or actuated component.

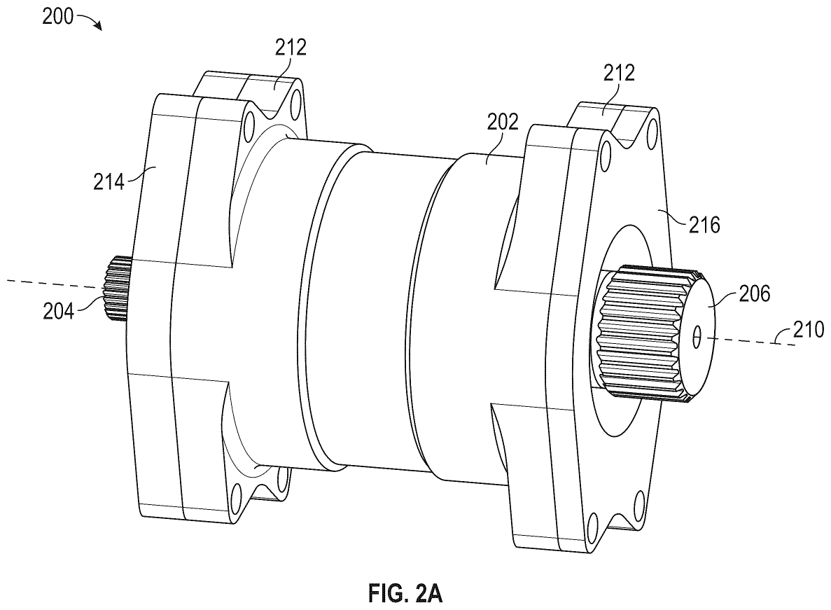

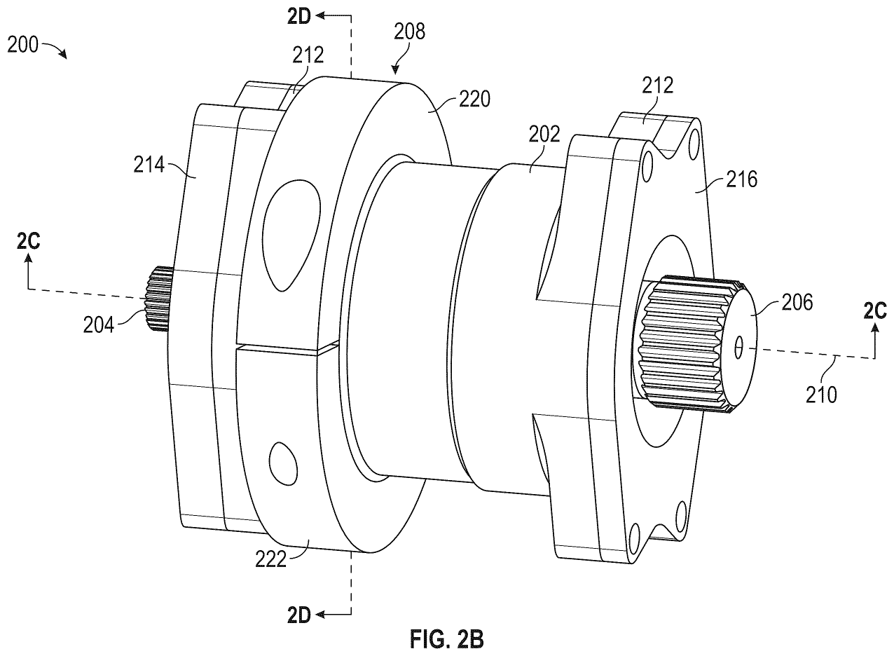

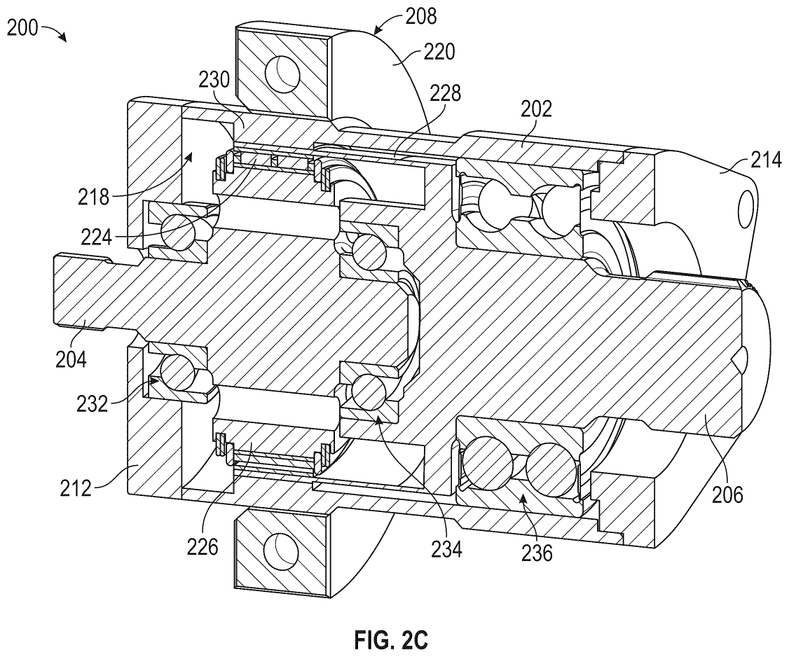

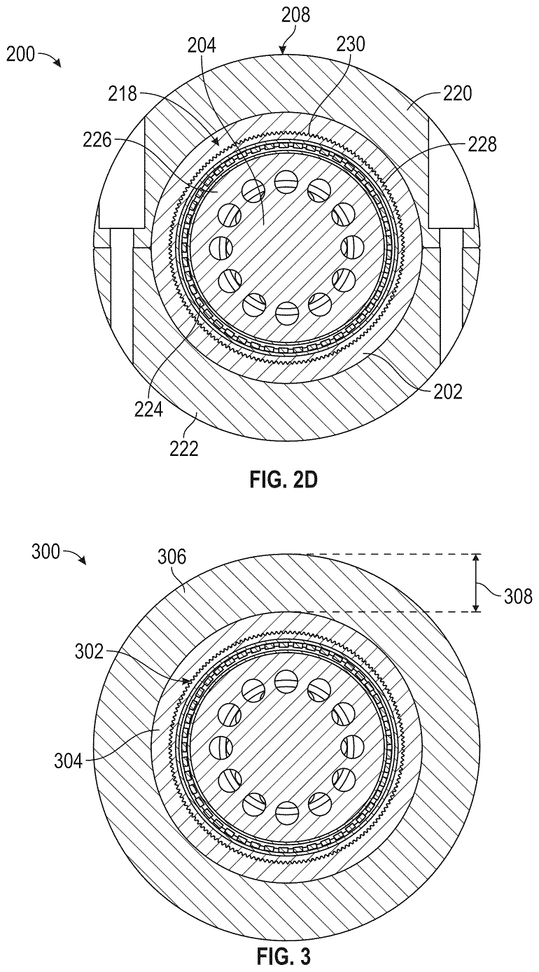

Referring now to FIGS. 2A-2D, schematic illustrations of a harmonic gear box assembly 200 in accordance with an embodiment of the present disclosure are shown. FIG. 2A is a perspective view of a housing 202 of the harmonic gear box assembly 200 illustrating an input shaft 204 and an output shaft 206 arranged within the housing 202. FIG. 2B illustrates the harmonic gear box assembly 200 with a torque limiting sleeve 208 installed to the housing 202. FIG. 2C illustrates a cross-sectional view taken along the line 2C-2C shown in FIG. 2B, and FIG. 2D illustrates a cross-sectional view taken the line 2D-2D shown in FIG. 2B.

The harmonic gear box assembly 200 defines an axis 210 that extends through the housing 202 and, in this illustrative configuration, is centered along both the input shaft 204 and the output shaft 206. In other configurations, one or both of the shafts (input and/or output) may be set or positioned off-center from the axis through the housing of the harmonic gear box assembly. The input shaft 204 may be configured to operably connect to an actuator, power source, or the like, to receive rotational energy as an input. The output shaft 206 may be configured to operably connect to a component to be actuated. In some configurations, the input shaft 204 may be coupled to a motor or driving mechanism that rotates the input shaft 204. The housing 202 may include, as shown, one or more flanges 212 that are arranged to receive covers 214, 216 that fixedly attach to the flanges 212 to enclose a gear assembly 218 therein. An input housing cover 214 is arranged to secure the input end of the housing 202 and an output housing cover 216 is arranged to secure the output end of the housing 202. The covers 214, 216 are configured to retain and secure the elements of the gear assembly 218 within the housing 202. Each of the input shaft 204 and the output shaft 206 are operably coupled to or form a part of the gear assembly 218, as shown and described herein. In operation, as the input shaft 204 is rotated, the rotational force maybe transferred to the output shaft 206 via the gear assembly, thus enabling actuation of a component to be actuated that is operably coupled to the output shaft 206. The component to be actuated, in accordance with some non-limiting embodiments of the present disclosure, may be components or elements of an aircraft, including, but not limited to doors, flaps, ailerons, control surfaces, thrust reversers, and the like, as will be appreciated by those of skill in the art.

As shown in FIG. 2B, the torque limiting sleeve 208 is arranged on the housing 202. When installed, an interior surface or inner diameter surface of the torque limiting sleeve 208 contacts the exterior surface or outer diameter surface of the housing 202. In this illustrative embodiment, the torque limiting sleeve 208 is arranged as a two-piece component that is clamped about the housing 202. Accordingly, in this non-limiting configuration, the torque limiting sleeve 208 is formed of a first sleeve section 220 and a second sleeve section 222 that are fixedly attached together, such as by fasteners, welding, clamps, adhesives, or the like, as will be appreciated by those of skill in the art. In the illustrative configuration, the two sleeve sections 220, 222 are configured to be joined together using fasteners. In other configuration, the torque limiting sleeve 208 may be a complete, single piece or continuous ring that is slid over a portion of the housing (e.g., if one of the flanges 212 is not present). In still other configurations, the torque limiting sleeve 208 may be formed from more than two sections.

FIGS. 2C-2D are cross-sectional views of the harmonic gear box assembly 200, showing features of the gear assembly 218 that is arranged within the housing 202. The gear assembly 218 includes a harmonic wave generator bearing 224 arranged on an exterior surface of the input shaft 204. The input shaft 204 includes an elliptical hub 226 which is positioned relative to the other components of the gear assembly 218. Arranged radially outward from the harmonic wave generator bearing 224 is a harmonic gear flex spline 228. The harmonic gear flex spline 228 is attached to or integrally formed with and is part of the output shaft 206. Radially outward from the harmonic gear flex spline 228 is a harmonic circular gear 230 that is built into or part of the housing 202. The harmonic circular gear 230 is aligned axially along the axis 210 with the harmonic gear flex spline 228, the harmonic wave generator bearing 224, and the elliptical hub 226. The harmonic circular gear 230 may be formed as a toothed portion or surface of the housing 202 and is a stationary component.

In operation, the input shaft 204 will rotate and the elliptical hub 226 will cause the harmonic wave generator bearing 224 to push or urge radially outward against the harmonic gear flex spline 228, which engages with the harmonic circular gear 230 of the housing 202. The harmonic gear flex spline 228 is thus rotated in engagement with the harmonic circular gear 230 of the housing 202 and causes the output shaft 206 to rotate. The input shaft 204 may be supported on one or more sets of wave generator bearings 232, 234 and the output shaft 206 may be supported on one or more sets of output bearings 236. The bearings 232, 234, 236 are arranged to ensure that the input and output shafts 204, 206 are free to rotate within the housing 202 and to allow the input shaft 204 to rotate independent or separate from the output shaft 206 (e.g., when the teeth of the gear assembly 218 are not engaged).

The torque limiting sleeve 208 is provided to limit the torque output of an actuator that the harmonic gear box assembly 200 is associated with. The limits on torque may be implemented to protect against damage to the structural components or elements that are operably connected to the actuator having the harmonic gear box assembly 200. In a configuration with the torque limiting sleeve 208, the gear assembly may ratchet such that the input shaft spins, but the output shaft remains stationary because the housing 202 may expand outward separating the contact between the harmonic gear flex spline 228 and the harmonic circular gear 230 of the housing 202. As the torque increases, the ratcheting occurs, decoupling the gear teeth of the harmonic gear box assembly 200. The torque limiting sleeve 208 is arranged to prevent outward expansion of the housing 202, thus ensuring continuous coupling or contact between the gear teeth of the harmonic gear box assembly 200.

The torque limiting sleeve 208 may be made from a material that is the same as the housing 202 or may be formed of a different material therefrom. In some embodiment having different materials, the material of the torque limiting sleeve 208 may be selected to be a malleable yet strong material (e.g., carbon fiber wrap, more malleable metal than the housing, etc.). In various embodiments, the torque limiting sleeve 208 may be formed from metals (e.g., steel, alloys, etc.), carbon fiber wraps, or the like. As noted above, the torque limiting sleeve 208 may be attached to the housing 202 by various mechanisms. For example, and without limitation. It will be appreciated that the type of attachment mechanism of the torque limiting sleeve 208 to the housing 202 may be dependent, in part, upon the material of the torque limiting sleeve 208 and/or the geometric arrangement thereof. In some configurations, the attachment or mounting of the torque limiting sleeve 208 to the housing 202 may be provided by friction engagement (e.g., compression from fasteners that join two or more sleeve sections). In other embodiments, the torque limiting sleeve 208 may be held in place by directly coupling the torque limiting sleeve 208 to the housing 202, such as at the flange 212, by a fastener, clamp, or the like. In some embodiments, a stop may be used to retain lock the axial position of the torque limiting sleeve 208 relative to the housing 202 and thus ensure the torque limiting sleeve 208 is positioned radially outward from the gear assembly 218.

Turning now to FIG. 3, a schematic illustration of a harmonic gear box assembly 300 in accordance with an embodiment of the present disclosure is shown. The harmonic gear box assembly 300 may be arranged similar to that shown and described above. The harmonic gear box assembly 300 includes a gear assembly 302 arranged within a housing 304. Similar to the configuration of FIGS. 2A-2D, a torque limiting sleeve 306 is arranged radially outward from the housing 304, and axially positioned and aligned with the gear assembly 302. The torque limiting sleeve 306 has a radial thickness 308. The radial thickness 308 of the torque limiting sleeve 306 may be set to ensure a desired torque limiting on the gear assembly 302. A greater radial thickness 308 results in a higher torque limiting, which may be a substantially linear relationship (as radial thickness increases, the torque limit increases). The torque limiting sleeve 306 may be removable from the housing 304, and thus different torque limiting sleeves may be installed onto a given housing of a harmonic gear box assembly allowing of an adjustable or customizable configuration. As such, if a higher (or lower) torque limit is required for a given application, a torque limiting sleeve may be selected with an appropriate radial thickness associated with the desired torque limit.

FIG. 4 illustrates a side view schematic illustration of a harmonic gear box assembly 400 in accordance with an embodiment of the present disclosure. The harmonic gear box assembly 400 may be arranged similar to that shown and described above. The harmonic gear box assembly 400 includes a gear assembly 402 arranged within a housing 404. Similar to the above configurations, a torque limiting sleeve 406 is arranged radially outward from the housing 404 and axially positioned and aligned with the gear assembly 402. FIG. 4 illustrates two options for retaining or attaching the torque limiting sleeve 406 to the housing 404. In one configuration, one or more fasteners 408 may be used to connect the torque limiting sleeve 406 to a flange 410 of the housing 404. The fasteners 408 may pass through the material of the torque limiting sleeve 406 and the flange 410. Alternatively, or in combination with the configuration of the fasteners 408, an axial stop 412 may be provided on one side of the torque limiting sleeve 406 such that the torque limiting sleeve 406 is axially bounded between the flange 410 and the axial stop 412.

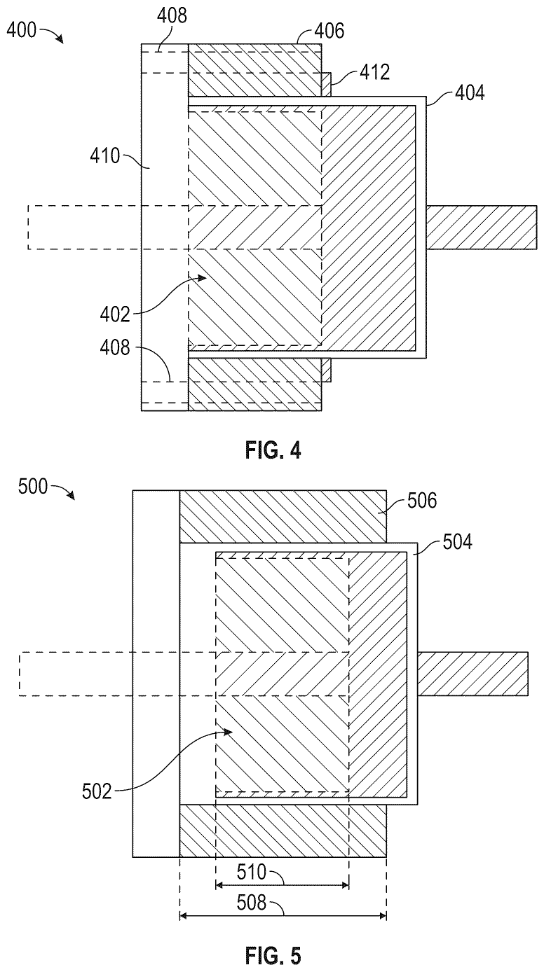

FIG. 5 illustrates a side view schematic illustration of a harmonic gear box assembly 500 in accordance with an embodiment of the present disclosure. The harmonic gear box assembly 500 may be arranged similar to that shown and described above. The harmonic gear box assembly 500 includes a gear assembly 502 arranged within a housing 504. Similar to the above configurations, a torque limiting sleeve 506 is arranged radially outward from the housing 504 and axially positioned and aligned with the gear assembly 502. The configuration of FIG. 5 illustrates that an axial length 508 of the torque limiting sleeve 506 may be different than an axial length 510 of the gear assembly 502. The illustrative configuration in FIG. 5 has the axial length 508 of the torque limiting sleeve 506 greater than the axial length 510 of the gear assembly 502. In other embodiments, the axial length 508 of the torque limiting sleeve 506 may be less than the axial length 510 of the gear assembly 502. The selection of the relative axial lengths may be based, in part, on the specific application.

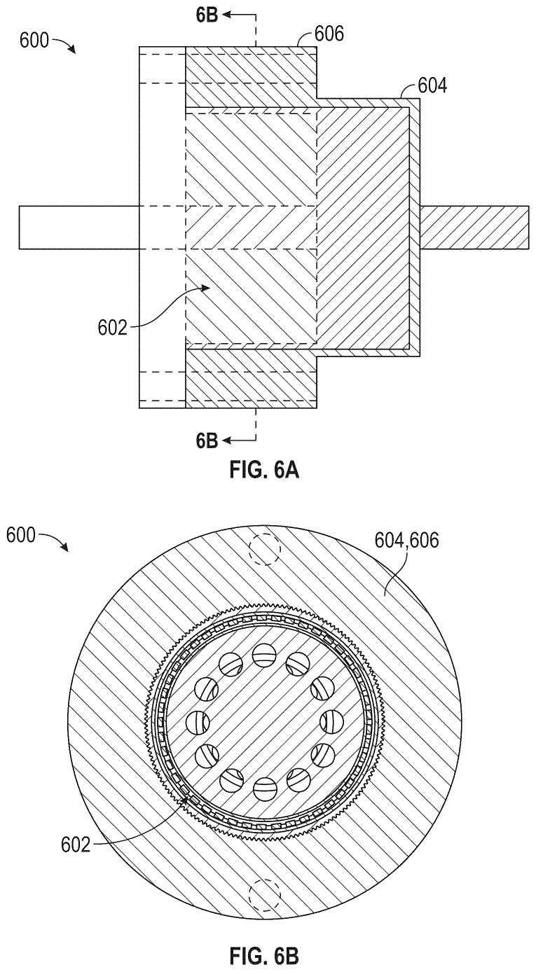

FIGS. 6A-6B are schematic illustrations of a harmonic gear box assembly 600 in accordance with an embodiment of the present disclosure. FIG. 6A illustrates a side cross-sectional view of the harmonic gear box assembly 600 and FIG. 6B illustrates a cross-sectional view of the harmonic gear box assembly 600 viewed along the line 6B-6B shown in FIG. 6A. The harmonic gear box assembly 600 may be arranged similar to that shown and described above. The harmonic gear box assembly 600 includes a gear assembly 602 arranged within a housing 604. Similar to the above configurations, a torque limiting sleeve 606 is arranged radially outward from the housing 604 and axially positioned and aligned with the gear assembly 602. The configuration of FIGS. 6A-6B illustrates that the torque limiting sleeve 606 may be integrally formed with the housing 604. In comparison to the above described embodiments, the configuration of the torque limiting sleeve 606 is not removable or interchangeable. That is, in the embodiments of the previously described configurations, the respective torque sleeves may be removed and are interchangeable components. Such interchangeability may enable customization and application of a torque limiting sleeve having a specific imposed torque limit. In contrast, the configuration of the harmonic gear box assembly 600 has a fixed torque limiting sleeve that is defined as an increased radial thickness of the housing 604 at the axial location/position of the gear assembly 602. The integrally formed torque limiting sleeve 606 may otherwise provide similar functionality as that shown and described above.

Advantageously, embodiments of the present disclosure are directed to a torque limiting device or configuration that may be implemented on gear box assemblies for actuators, such as aircraft actuators. The torque limiting sleeves described herein provide for an improved mechanism as compared to prior solutions. For example, the torque limiting sleeves of the present disclosure are relatively simple with respect to construction, being a single piece, or few pieces that are joined together and installed about the circumference of a housing of a gear box assembly. The placement of the torque limiting sleeve on the house positions the torque limiting sleeve radially outward from the gear assembly within the housing of the gear box assembly. The torque limiting sleeves may be customized or sized and configured to achieve a desired torque limit. Further, in accordance with some embodiments, the torque limit applied to a given gear box assembly may be customized by selecting or employing a torque limiting sleeve having a specific radial thickness, advantageously allowing for customized torque limiting. Furthermore, advantageously, because the torque limiting sleeves disclosed herein are applied or installed directly on (or are part of) the housing of the gear box assembly, no additional components or structures are required to be coupled along the transmission line (e.g., input and output shafts).

The use of the terms “a”, “an”, “the”, and similar references in the context of description (especially in the context of the following claims) are to be construed to cover both the singular and the plural, unless otherwise indicated herein or specifically contradicted by context. The modifiers or terms “about” and/or “substantially” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other. As used herein, the terms “about” and “substantially” are intended to include the degree of error associated with measurement of the particular quantity based upon the equipment available at the time of filing the application. For example, the terms may include a range of ±8%, or 5%, or 2% of a given value or other percentage change as will be appreciated by those of skill in the art for the particular measurement and/or dimensions referred to herein.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments.

Accordingly, the present disclosure is not to be seen as limited by the foregoing description but is only limited by the scope of the appended claims.

What is claimed is:

1. A gearbox assembly for an actuator comprising:
a housing;
a gear assembly arranged within the housing; and
a torque limiting sleeve arranged on an exterior of the housing, wherein the torque limiting sleeve is axially positioned radially outward from the gear assembly.

2. The gearbox assembly of claim 1, wherein the torque limiting sleeve is integrally formed with the housing, and the torque limiting sleeve comprises a radial thickness of the housing at a position axially outward from the gear assembly that is greater than a radial thickness of the housing not axially aligned with the gear assembly.

3. The gearbox assembly of claim 1, wherein the torque limiting sleeve comprises at least two sleeve sections that are secured together about the housing.

4. The gearbox assembly of claim 1, wherein torque limiting sleeve comprises an inner diameter surface that is arranged in contact with an outer diameter surface of the housing.

5. The gearbox assembly of claim 4, wherein the torque limiting sleeve is retained on the housing by a clamping force and friction between the inner diameter surface and the outer diameter surface.

6. The gearbox assembly of claim 1, wherein the torque limiting sleeve is removably attached to the housing.

7. The gearbox assembly of claim 1, wherein the torque limiting sleeve and the housing are formed from the same material.

8. The gearbox assembly of claim 1, wherein the torque limiting sleeve is formed a material different from a material of the housing.

9. The gearbox assembly of claim 1, wherein the torque limiting sleeve has an axial length that is equal to an axial length of the gear assembly within the housing.

10. The gearbox assembly of claim 1, wherein the torque limiting sleeve has an axial length that is greater than an axial length of the gear assembly within the housing.

11. The gearbox assembly of claim 1, wherein the torque limiting sleeve has an axial length that is less than an axial length of the gear assembly within the housing.

12. The gearbox assembly of claim 1, wherein the gear assembly comprises an elliptical hub, a harmonic wave generator bearing arranged radially outward from the elliptical hub, a harmonic gear flex spline arranged radially outward from the harmonic wave generator bearing, and a harmonic circular gear arranged radially outward from the harmonic gear flex spline, wherein the harmonic gear flex spline is configured to engage with the harmonic circular gear.

13. The gearbox assembly of claim 12, wherein the elliptical hub is coupled to an input shaft and the harmonic gear flex spline is coupled to an output shaft.

14. The gearbox assembly of claim 1, further comprising an axial stop installed on an exterior of the housing and configured to secure an axial position of the torque limiting sleeve on the housing.

15. The gearbox assembly of claim 1, wherein the housing comprises a flange, wherein the torque limiting sleeve is fixedly connected to the flange.

16. An aircraft actuator system comprising:
a component to be actuated;
an actuator; and
a gearbox assembly operably arranged between the actuator and the component to be actuated, wherein the gearbox assembly comprises:
a housing;
a gear assembly arranged within the housing, wherein the gear assembly is configured to couple an input shaft connected to the actuator with an output shaft connected to the component to be actuated; and
a torque limiting sleeve arranged on an exterior of the housing, wherein the torque limiting sleeve is axially positioned radially outward from the gear assembly.

17. The aircraft actuator system of claim 16, wherein the torque limiting sleeve is removably attached to the housing.

18. The aircraft actuator system of claim 16, wherein the torque limiting sleeve has an axial length that is equal to an axial length of the gear assembly within the housing.

19. The aircraft actuator system of claim 16, wherein the gear assembly comprises an elliptical hub, a harmonic wave generator bearing arranged radially outward from the elliptical hub, a harmonic gear flex spline arranged radially outward from the harmonic wave generator bearing, and a harmonic circular gear arranged radially outward from the harmonic gear flex spline, wherein the harmonic gear flex spline is configured to engage with the harmonic circular gear.

20. The aircraft actuator system of claim 19, wherein the elliptical hub is coupled to the input shaft and the harmonic gear flex spline is coupled to the output shaft.
